(19) United States
(12) Patent Application Publication
(10) Pub. No.: US 2007/0061719 A1
(43) Pub. Date: Mar. 15, 2007

(54) Address data collection and formatting apparatus and method for worldwide address formats

(75) Inventor: Merry Law, Highland Park, NJ (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: WorldVu LLC

(21) Appl. No.: 11/389,061

(22) Filed: Mar. 27, 2006

Related U.S. Application Data
(60) Provisional application No. 60/716,496, filed on Sep. 14, 2005.

(51) Int. Cl. G06F 9/00

(52) U.S. Cl. 715/700; 715/703; 715/764; 715/810

(57) ABSTRACT

An address data collection system collects contact information in a variety of country postal address, telephone data and other contact information formats or standards. The address data collection system includes a country selector to receive country selection input data, and an address form composer that accesses a country information database to select an appropriate template and retrieve country-specific information, which is integrated with the template to create a country-specific address form. The system also includes an address saver that stores address input data in an address database. The system further includes an error generator that sends an error message if the input data is incomplete or otherwise in error, as well as a confirmation sender that sends a confirmation message indicating that the contact information has been successfully received and stored.

### CROSS-REFERENCE TO RELATED APPLICATIONS

This application claims priority and is a continuation of provisional U.S. patent application entitled, ADDRESS DATA COLLECTION AND FORMATTING APPARATUS AND METHOD FOR WORLDWIDE ADDRESS FORMATS, filed Sep. 14, 2005, having a Ser. No. 60/716,496, the disclosure of which is hereby incorporated by reference in its entirety.

### FIELD OF THE INVENTION

The present invention relates generally to data processing. More particularly, the present invention relates to address data collection and formatting in a variety of differing country formats or standards.

### BACKGROUND OF THE INVENTION

Worldwide web-based e-commerce has resulted in a proliferation of companies that receive orders from foreign locations. Typically, a web page order form from a U.S.-based company, for example, includes text input fields for the customer's name, address, city, state and zip code in the postal address standard format used in the United States, and one or more text input fields for a telephone number according to the North American Numbering Plan. Similarly, businesses that are based outside of the U.S. typically use an order form with text input fields based on the postal address standard of the country where the company is located.

Thus, when a customer attempts to input an address from a location that uses a different postal address standard than that of the web page order form, the text input fields often do not correspond to the required information for the customer's local postal format standard. As a result, the information input by customers sometimes cannot be used or is incomplete. In other cases, the information input by a customer can be reformatted into a usable form; however, this often requires manual revision, which can be excessively costly and time consuming. Furthermore, reformatting can be outsourced to a vendor or a contractor; however, in this case, data security and privacy concerns must also be addressed.

Accordingly, it is desirable to provide a method and apparatus that facilitates the collection of postal address and other contact information in a variety of address formats or standards.

### SUMMARY OF THE INVENTION

The foregoing needs are met, to a great extent, by the present invention, wherein in one aspect an apparatus is provided that in some embodiments can collect accurate postal address and other contact information in a variety of country address formats or standards.

In accordance with one aspect of the present invention, a computer-implemented method of collecting address data in multifarious country formats can include sending a country selection form over a communication network to a remote computer and receiving country selection input data indicating a selected country. The method can also include selecting a template corresponding to the selected country from a plurality of predetermined templates and composing a country-specific address form based on the template.

In accordance with another aspect of the present invention, a computer program product for collecting address data in multifarious country formats, including a computer-readable medium encoded with instructions configured to be executed by a processor in order to perform predetermined operations including sending a country selection form over a communication network to a remote computer and receiving country selection input data indicating a selected country. The predetermined operations can also include selecting a template corresponding to the selected country from a plurality of predetermined templates and composing a country-specific address form based on the template.

In accordance with yet another aspect of the present invention, an address data collector to gather address data in multifarious national formats can include a country selector configured to send a country selection form over a communication network to a remote computer and receive country selection input data indicating a selected country. The address data collector can also include an address form composer configured to select a template corresponding to the selected country from a plurality of predetermined templates and compose a country-specific address form based on the template.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating an address data collection system according to an embodiment of the invention.

FIG. 2 illustrates a representative country selection form suitable for use with the address data collection system of FIG. 1.

FIG. 3 illustrates a representative data table including country-specific information for use with the address data collection system of FIG. 1.

FIG. 4 is an example address form in the postal address format standard of French Guiana that can be created by the address data collection system of FIG. 1.

FIG. 5 is an example address form in the postal address format standard of Kyrgyzstan that can be created by the address data collection system of FIG. 1.

FIG. 6 is a flowchart illustrating steps that may be followed in accordance with one embodiment of the method or process in order to collect address data in a variety of country formats.

### DETAILED DESCRIPTION

An embodiment in accordance with the present invention provides an address data collection system that can collect accurate address data and other contact information in a variety of different postal address formats or standards, telephone number standards, and the like. The address data collection system can thus reduce the need for manual revision of address data and increase deliverability of requested information or products.

The address data collection system can include a country selector to receive country selection input data. The address data collection system can also include an address form composer that can access a country information database to select a template corresponding to the selected country and integrate country-specific information with the template to create a country-specific address form tailored to the selected country. The address data collection system can further include an address saver that stores the address data and other contact information in an address database. In addition, the address data collection system can include an error generator that sends an error message to the user if the address data is incomplete or is otherwise in error, and a confirmation sender that sends a confirmation message indicating that the address data has been successfully received and stored.

Throughout this disclosure, the term “address” is used broadly to signify a postal address or a street address, as well as other contact information, such as names, titles, telephone and fax numbers, or email addresses. Generally, an “address” can be inclusive of merely a portion of any one of these entities, or of a collection or combination of more than one of these entities. Use of the various terms “address,” “postal address,” “telephone data,” “contact information,” or the like, individually or in combination, is not meant to distinguish between one type of information and another, but rather to emphasize, in places, that specific types of contact information may apply and are expressly included, even though implicitly included throughout the disclosure. Nevertheless, more literal or narrow meanings, significations or interpretations should be understood to be encompassed by the term “address” as used in this disclosure.

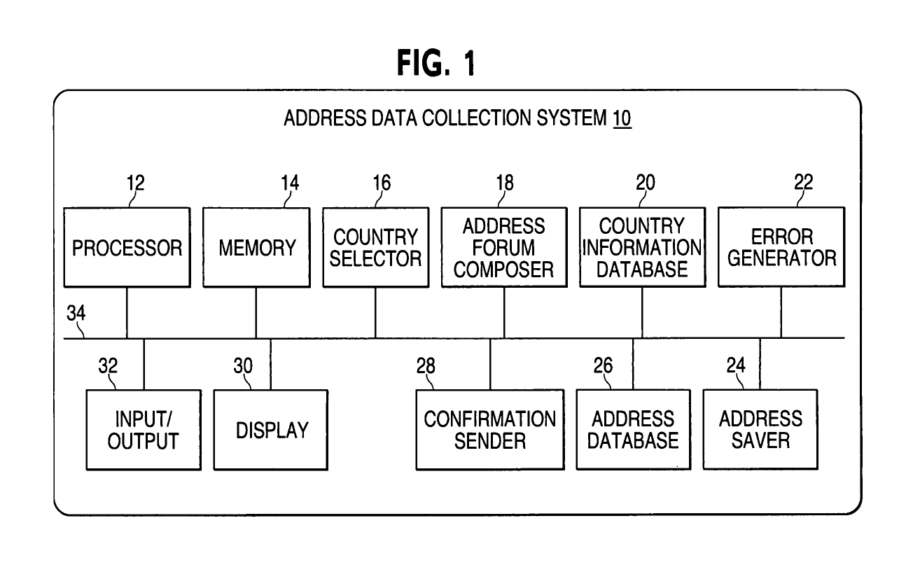

The invention will now be described with reference to the drawing figures, in which like reference numerals refer to like parts throughout. An address data collection system 10 can include a processor 12, a memory 14, a country selector 16, an address form composer 18, a country information database 20, an error generator 22, an address saver 24, an address database 26, a confirmation sender 28, a display 30, and an input/output device 32, all of which can be coupled to one another by a local data link, such as the data bus 34 shown in FIG. 1. The address data collection system 10 can provide an address form in a variety of different country formats, into which a user can input address data and other contact information. The address data collection system 10 can also save the address data and other contact information in the address database 26 and send a confirmation indicating that the address data has been successfully received and stored.

The processor 12, the memory 14, the display 30 and the input/output device 32 can be part of a general computing device, such as a personal computer (PC), a server, a mainframe computer or a personal digital assistant (PDA). The remaining components can include programming code, such as source code, object code or executable code, stored on a computer-readable medium that can be loaded into the memory 14 and executed by the processor 12 in order to perform the functions of the address data collection system 10. Thus, in some embodiments, the address data collection system 10 can be executed on a common PC. However, in other embodiments the address data collection system 10 can be executed on any suitable processor, such as a server, a mainframe computer, a PDA, a collection of networked servers or PCs, or the like. Additionally, as modified or improved versions of the address data collection system 10 are developed, for example, in order to revise or add a template or country-specific information, software associated with the PC or other processor can be updated.

In various embodiments, the address data collection system 10 can be coupled to a communication network, which can include any viable combination of devices and systems capable of linking computer-based systems, such as the Internet; an intranet or extranet; a local area network (LAN); a wide area network (WAN); a direct cable connection; a private network; a public network; an Ethernet-based system; a token ring; a value-added network; a telephony-based system, including, for example, T1 or E1 devices; an

Asynchronous Transfer Mode (ATM) network; a wired system; a wireless system; an optical system; a combination of any number of distributed processing networks or systems or the like.

The address data collection system 10 can be coupled to the communication network by way of the local data link, which in various embodiments can incorporate any combination of devices—as well as any associated software or firmware-configured to couple processor-based systems, such as modems, network interface cards, serial buses, parallel buses, LAN or WAN interfaces, wireless or optical interfaces and the like, along with any associated transmission protocols, as may be desired or required by the design.

An embodiment of the present invention can communicate information to the user and request user input by way of an interactive, menu-driven, visual display-based user interface, or graphical user interface (GUI). The user interface can be executed, for example, on a personal computer (PC) with a mouse and keyboard, with which the user may interactively input information using direct manipulation of the GUI. Direct manipulation can include the use of a pointing device, such as a mouse or a stylus, to select from a variety of selectable fields, including selectable menus, drop-down menus, tabs, buttons, bullets, checkboxes, text boxes, and the like. Nevertheless, various embodiments of the invention may incorporate any number of additional functional user interface schemes in place of this interface scheme, with or without the use of a mouse or buttons or keys, including for example, a trackball, a touch screen or a voice-activated system.

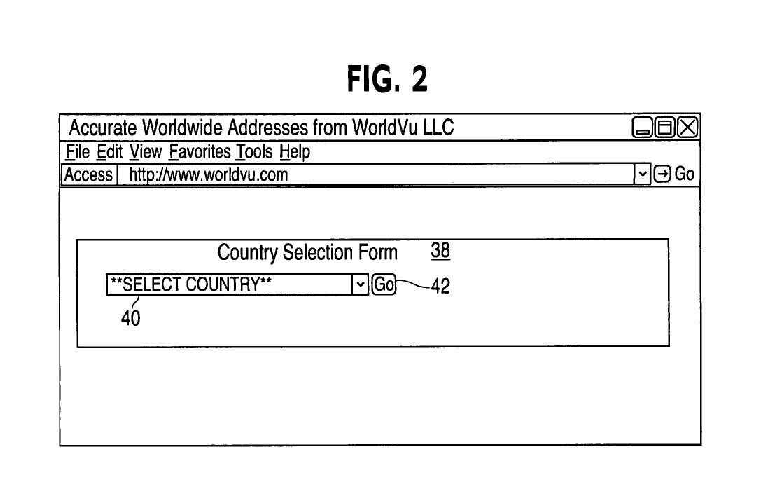

The address data collection system 10 can include a country selector 16 to solicit and receive country selection input data. For example, the country selector 16 can prepare an interactive country selection form 38, such as that shown in FIG. 2, to request user input regarding a selected country. The country selection form 38 can be prepared as a HyperText Markup Language (HTML) document including one or more input controls, for example, buttons, check boxes, radio buttons, drop-down menus, text fields, file select, hidden controls and object controls; as well as display objects that provide a visual display, but do not have the capability to receive user input. In some embodiments, the country selector 16 can display the country selection form 38, for example, on the display 30, for viewing and manipulation by a user. However, in other embodiments, the country selector 16 can send the country selection form 38, for example, by way of the Hypertext Transfer Protocol (HTTP), over a communication network, such as the Internet, to a remote computer, or “client,” for display.

The user can then manually enter country selection input, for example, by way of an input control, such as the drop-down menu 40 shown in FIG. 2. In some embodiments, the drop-down menu 40 can include a list of various countries for which the address data collection system 10 is configured to receive address data and other contact information in a local or country-specific format. For example, the drop-down menu 40 can include a list of up to two hundred or more countries, nations, territories or other political or geographic regions that have a postal address format standard or a generally-accepted postal address format. In other embodiments, the user can manually enter the country selection input by typing in the country name or a portion of the country name.

In some embodiments, the country selection form 38 can include a send button, such as the “Go” button 42 shown in FIG. 2, or other control to indicate that a country selection has been made and should be sent to the address data collection system 10. Thus, the country selector 16 can receive the entered country selection input data indicating the selected country for use by the address data collection system 10, for example, over a communication network, such as the Internet, from the client.

The country selector 16 in an alternative embodiment can identify the country of origin of a transmission, such as an email or an HTML document received over a communication network. For example, a Uniform Resource Locator (JRL) associated with the client can include a two-character country designation that can be recognized or identified by the country selector 16 in order to automatically determine a selected country without requiring input from the user. In this embodiment, the country selector 16 can optionally choose to not send a country selection form 38 to the client.

The address data collection system 10 can further include an address form composer 18 that can access a country information database 20 to retrieve country-specific information regarding postal address, telephone data, and other contact information formats or standards corresponding to the selected country. For example, in some embodiments the address form composer 18 can access the country information database 20 in order to retrieve a template code corresponding to the selected country, and then copy the associated template from a pool of stored templates that generally conform to a variety of basic postal address formats. Other embodiments of the invention can include up to thirty-five or more templates for postal address, telephone data, and other contact information formats or standards.

In addition, the address form composer 18 can retrieve customization details regarding the precise postal address, telephone data and other contact information format or standard of the selected country from the country information database 20 and customize the template with this country-specific information to compose an interactive country-specific address form that is appropriate for the selected country. In some embodiments, the address form can be an HTML document including one or more input controls, for example, buttons, check boxes, radio buttons, drop-down menus, text fields, file select, hidden controls and object controls; as well as display objects that provide a visual display, but do not have the capability to receive user input.

In some embodiments, the address form composer 18 can display the address form, for example, on the display 30, for viewing and manipulation by a user. However, in other embodiments, the address form composer 18 can further send the customized address form, for example, by way of the HyperText Transfer Protocol (HTTP), to a client over a communication network, such as the Internet, to a client for display. In either case, a user can complete the address form by entering text data into the text fields, for example, using an input device, such as a keyboard.

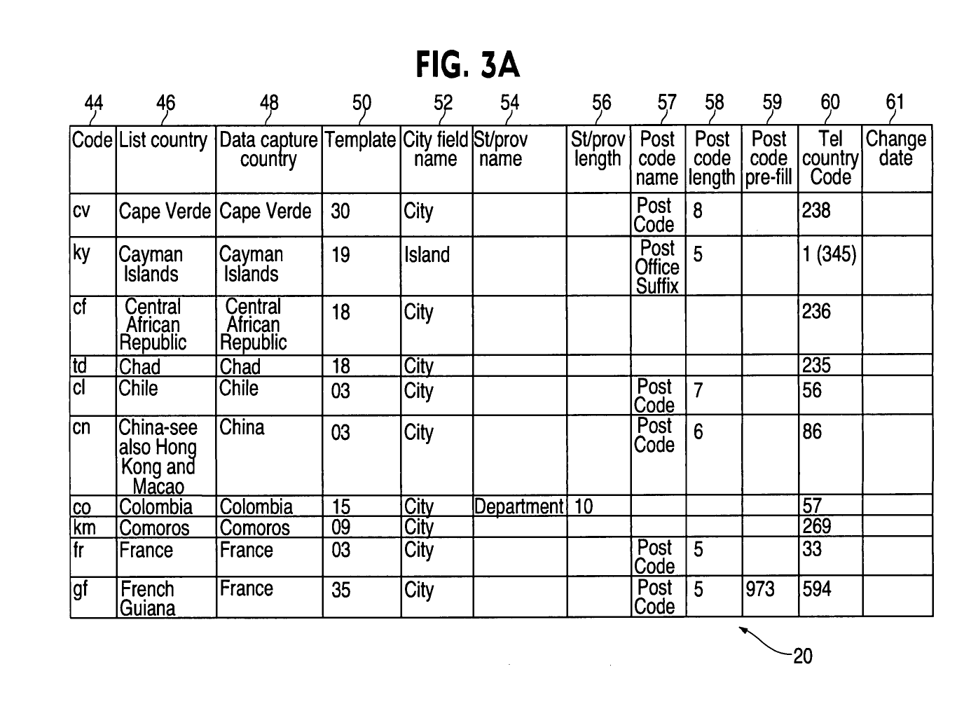

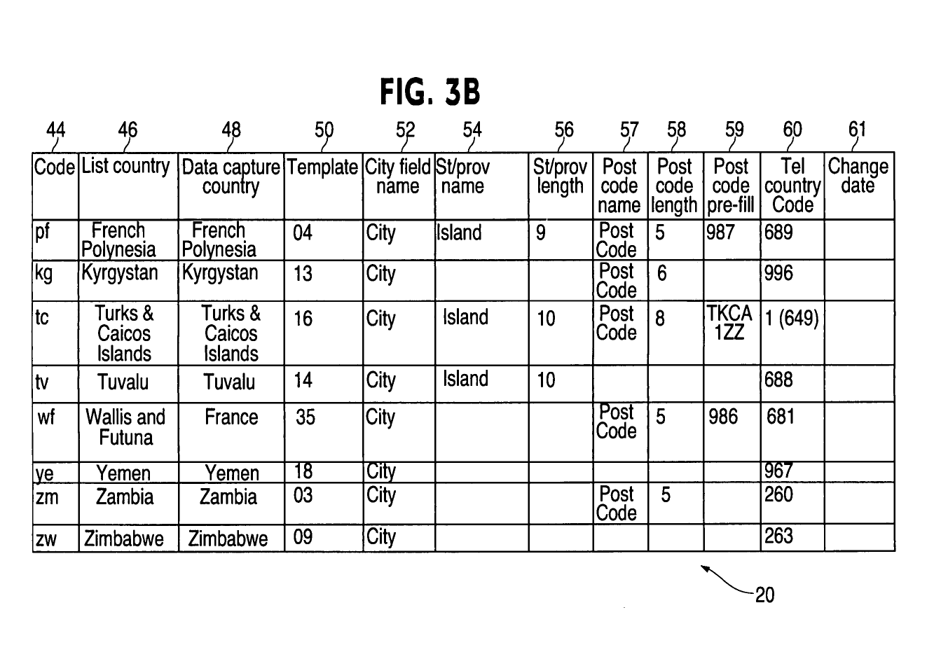

For example, a representative country information database 20 in the form of a text data table is shown in FIG. 3. In some embodiments, the country information database 20 can include, for example, country-specific information regarding a country designation code 44, the list country 46, the data capture country 48, a template number 50, city field name 52, a state or province name 54, a state or province field length 56, a post code name 57, a post code field length 58, post code pre-fill 59, a telephone country code (or area code) 60 and a revision or change date 61.

The country designation code 44 can represent the selected country, and can include, for example, a two-character designation used in a top-level Internet domain name, or Uniform Resource Locator (URL). The list country 46 can correspond to the selected country or country selection input data from a user received by the country selector 16. The data capture country 48 can correspond to an appropriate postal address country, which may differ from the list country 46. For example, French Guiana's mail service is handled by the postal service of France, so the appropriate postal address country for mail bound for French Guiana is France, rather than French Guiana, as shown in FIG. 3.

The template number 50 can include a number or code that indicates a specific template corresponding to the list country 46. The city field name 52 can include a country-specific label corresponding to a city field of the template. The state or province 54 can indicate a country-specific label for a local political entity, for example, state (e.g., in the U.S.), province (e.g., in Canada), caza (e.g., in Lebanon), county (e.g., in Ireland), department (e.g., in Colombia), island (i.e., in the Bahamas), or the like. The state or province field length 56 can indicate a maximum number of characters for state or province data to be entered by a user.

The post code name 57 can include a label for the local code used by the country 44 or other postal system—for example, “Postal Code” (e.g., in China), “Post Office Suffix” (e.g., in the Cayman Islands), “Zip Code” (e.g., in the U.S.), or the like. The post code field length 58 can include a number indicating the number of digits or characters used in a country post code. The post code pre-fill 59 can include specific or literal numbers or letters to be included, or prepopulated, in part or all of the postal code field (e.g., see entries for French Giana and Turks and Caicos Islands in FIG. 3). The telephone country code (or area code) 60 can include the telephone country code corresponding to the country 44, or “1” plus the area code for countries included in the North American Numbering Plan. The change date 61 can include the most recent date upon which a record has been modified.

Furthermore, the address form composer 18 can, for example, adjust the length of a text input field to conform with a postal address standard or a generally-accepted postal address format, such as the state or province field length 56. Similarly, the address form composer 18 can provide a label for a text input field, for example, a post code name 57 label from the country information database 20. Moreover, the address form composer 18 can prepopulate at least a portion of some of the text fields with predetermined textual address data from the country information database 20, such as the post code pre-fill 59, based on the country selection. In some embodiments, the address from composer 18 can prepopulate at least a portion of some of the text fields with predetermined textual address data based on user input entered in another of the text fields, for example, based on a postal code or phone number entry.

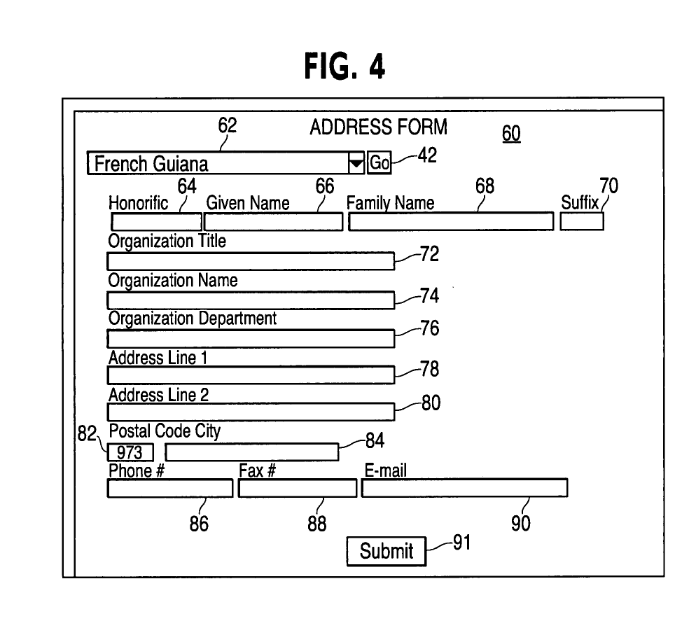

A specific example of an address form that can be created by the address form composer 18 is shown in FIG. 4. The address form 60 corresponds to the postal address standard format used in French Guiana. For example, the address form 60 includes a drop-down menu 62 that can display the current selected country and can be accessed by a user to select another country. The address form 60 also can include text input fields, including, for example, a title or “Honorific” field 62, a “Given Name” field 66, a “Family Name” field 68 and a “Suffix” field 70.

The address form 60 can further include additional fields, such as an “Organizational Title” 72, an “Organizational Name” 74, and an “Organizational Department” 76. In addition, the address form 60 can include one or more fields for address information, such as the “Address Line 1” 78 and “Address Line 2” 80 fields shown in FIG. 4. Furthermore, the address form 60 include a “Postal Code” field 82 and a “City Field” 84. The postal address standard in French Guiana, for example, does not require a state or province, so the corresponding field can be omitted. Moreover, the address form 60 can include a telephone number or “Phone #” field 86, a fax number or “Fax #” field 88 and an email address or “E-mail” field 90.

In addition, the address form 60 can include a send button, such as the “Submit” button 92 shown in FIG. 4, or other control to indicate that address data has been entered and should be sent to the address data collection system 10. Thus, the address data collection system 10 can receive the entered address input data, for example, over a communication network, such as the Internet, from the client.

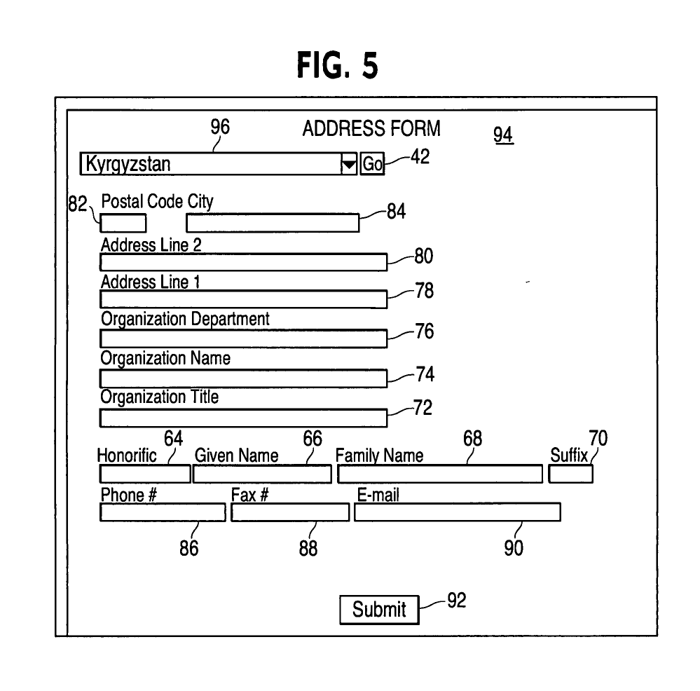

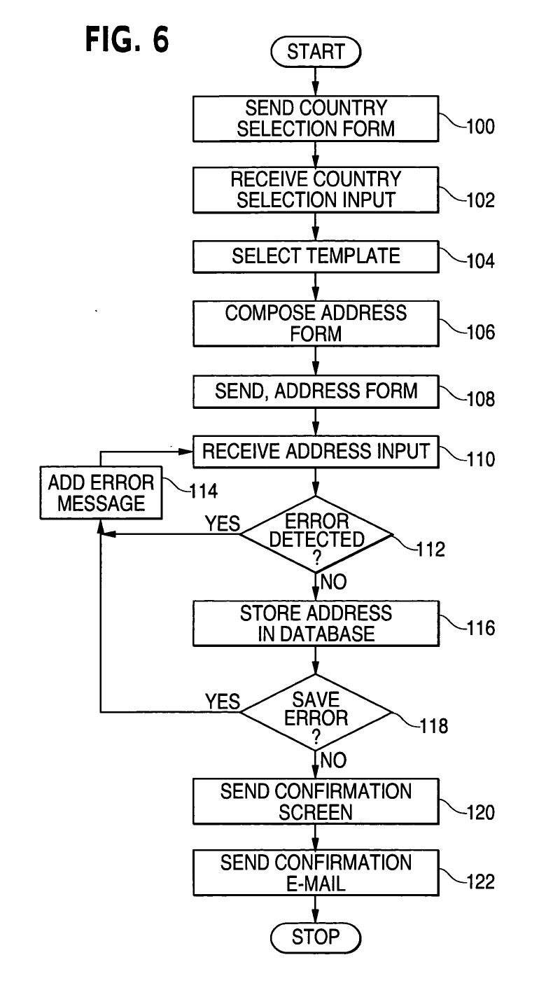

Another specific example of an address form 94 that can be created by the address form composer 18 is shown in FIG. 5. This address form 94 is formatted in a postal address standard used in Kyrgyzstan. The address form 94 can include a drop-down menu 96 to allow a user to select another country. The postal address format used in Kyrgyzstan requires that the postal code and city be placed at the top of the address, followed by street address information, organizational information, and finally by the recipient's name.

Thus, the address form 94 can include a “Postal Code” field 82 and a “City” field 84 near the top of the address form 94. Below these, the address form 94 can include an “Address Line 2” field 80 and an “Address Line 1” field 78. Next, the address form 94 can include an “Organization Department” field 76, an “Organization Name” field 74 and an “Organization Title” field 72. Below the organizational information, the address form 94 can include, for example, a title or “Honorific” field 64, a “Given Name” field 66, a “Family Name” field 68 and a “Suffix” field 70. Below the address fields, the address form 94 also can include a telephone number or “Phone #” field 86, a fax number or “Fax #” field 88 and an email address or “E-mail” field 90. As above, the address form 94 can include a “Submit” button 92 to indicate that address data has been entered and should be sent to the address data collection system 10.

The example address forms 60, 94 shown in FIG. 4 and FIG. 5 include correct English-language translations of designations and field labels, in accordance with an embodiment of the invention. However, alternative embodiments can also include correct designations and field labels in an official or predominant language of the selected country, or in another language used throughout or in regions of the selected country. For example, the address forms 60, 94 can include a drop-down menu from which the user can select a language in which to view the address forms 60, 94 from a list of predetermined languages.

Furthermore, the address forms 60, 94 can be integrated into an organization-specific customized entity form. For example, the address forms 60, 94 can be combined with company-specific order form fields to allow a user to place an order for a company product. The address forms 60, 94 can further be customized with a color scheme, background, trademark, logo, or the like, in order to match a company or other organization web site.

In addition, the address data collection system 10 can include an error generator 22 to notify the user if the address data or other contact information input by the user is incomplete, or otherwise in error. For example, the error generator 22 can determine whether text data has been received for each and every input field. If the address data is incomplete, or if the error generator 22 is able to detect an error in the received address data, the error generator 22 can send an HTML document including a text message indicating the nature of the error to the client to be displayed for viewing by the user, for example, requesting the user reenter the address data.

Furthermore, the address data collection system 10 can include an address saver 24 that can receive address data and other contact information entered in the address forms 60, 94 by the user, and can store the address data and other contact information in the address database 26. In some embodiments, the address database 26 can take the form of a flat file database, for example, a plain text file with one record per line, in which each record can be divided into fields with fixed column positions or by using delimiters, such as commas or tab spaces, to facilitate portability and searchability of the address data.

In alternative embodiments, the address database 26 can include any type of file that records textual information in any electronic format, such as text format (.txt), rich text format (.rtf), word format (.doc), Microsoft Excel workbook format (.xls), web page format (.htm or .html), XML spreadsheet format (.xml), comma delimited format (.csv), database format (.dbf), formatted text or space delimited text (.prn), Microsoft Access format (.mdb), another proprietary database format, or the like. Thus, the entries, or address input data, received from numerous users can be stored in a single address database 26, for example, with each address data record including a set number of fields, in a plain text format, such as the ASCII text character format, to facilitate portability and searchability of the address data.

In some embodiments of the address data collection system 10, the error generator 22 can notify the user if the address data is not successfully stored or saved by the address saver 24. For example, the error generator 22 can determine whether the address data has been successfully stored in the address database 26. If, for any reason, the address saver 24, the processor 12 or the memory 14 malfunctions, resulting in the address data not being successfully written to the address database 26, the error generator 22 can send an HTML document including a text message indicating the nature of the error to the client to be displayed for viewing by the user, for example, requesting the user reenter the address data. Otherwise, if the correct address data is available, for example, in a register, the address saver 24 can again store the address data and other contact information in the address database 26 in step 118.

Moreover, the address data collection system 10 can include a confirmation sender 28 that can be configured to send a confirmation message indicating that the address data has been successfully received and stored to the client for display and viewing by a user. For example, in some embodiments the confirmation sender 28 can send an email confirmation message to the email address input by the user in the address forms 60, 94. In addition, the confirmation sender 28 can send an HTML confirmation message to the client, for display and viewing by the user. Furthermore, the confirmation sender 28 can be configured to send a confirmation message to a web site owner, for example, an order fulfillment or marketing department within the organization collecting the address data, indicating that new address data has been successfully received and stored.

FIG. 7 illustrates a flowchart including steps that can be followed by the address data collection system 10 in order to collect address data in a country-specific format. The process can begin by passing to step 100, “send country selection form,” in which a country selector can send a country selection form, such as the country selection form shown in FIG. 2, to a client. For example, as described above, the country selector can send an HTML document, or web page, including a country selection input control to the client. The process then continues to step 102, “receive country selection input,” in which the country selector can receive country selection input data from the client corresponding to user input, for example, manual input entered into the client by the user via an input device, such as a keyboard indicating a selected country.

Then, in step 104, “select template,” an address form composer can select an appropriate template corresponding to the selected country—from a collection of address form templates corresponding to various countries. For example, as described above, the address form composer can access a country information database, retrieve a code corresponding to the correct template for the selected country, and copy the template. In step 106, “compose address form,” the address composer can access the country information database to retrieve country-specific information, and integrate the country-specific information into the selected template to compose a country-specific address form, as described above. Then in step 108, “send address form,” as described above, the address form composer can send the country-specific address form to the client for viewing and manipulation by a user.

Next in step 110, “receive address input,” as described above, an address saver can receive address input data from the client corresponding to user input, for example, manual input entered into the address form via a client input device, such as a keyboard. In step 112, “error detected,” an error generator can verify whether the address data is complete, for example, whether text data has been received for each input field in the country-specific address form. If the address data is incomplete, or if the error generator is able to detect an error in the received address data, as described above, the error generator can add an error message to the address form in step 114, to notify the user that the received address data is incomplete, or is otherwise in error.

In this case, the process can return to step 108, where the address form composer can resend the address form, including the error message, to the client for reentry or correction of the address data, and then to step 110, where the address saver can receive the reentered or corrected address data. In an alternative embodiment, the error generator can create and send a separate error message to the client, such as an HTML document or an email message, to notify the user that the received address data is incomplete or in error.

Otherwise, if the address data is complete, and the error generator is unable to detect any error in the received address data, in step 116, “store address in database,” as described above, the address saver can store the received address data in an address database, such as an ASCII text-formatted flat file database. As further described above, the address database can include address data received from a number of users in a series of records including searchable fields. Then, in step 118, “save error,” the error generator can verify whether the address data has been successfully saved. If, for any reason, the address data has not been successfully saved in the address database 26, the error generator can add an error message to the address form in step 114, to notify the user that the received address data was not successfully captured.

Next, in step 120, “send confirmation screen,” as described above, a confirmation sender can send a confirmation message, such as an HTML document, to the client indicating that the address data has been successfully received and stored. Similarly, in step 122, “send confirmation email,” the confirmation sender can send a confirmation email to the user's email address received in the address data indicating that the address data has been received and stored successfully.

The disclosed systems, computer-implemented methods and computer program products can be implemented using hardware, for example, in the form of one or more integrated circuits, microprocessors or controllers; or

using software, for example, in the form of stored program code representing computer program instructions; or using some combination of hardware and software. In this regard, FIG. 1 depicts an embodiment of the present invention implemented using several components of a general-purpose programmable machine, such as a personal computer (PC). It will be appreciated, however, that a computer typically can include many additional components.

Nonetheless, it is not necessary that all of the conventional computer components be shown in order to disclose an illustrative embodiment for practicing the invention. The general-purpose programmable machine can include a processor, such as a central processing unit (CPU), microprocessor, controller or control unit. The machine can also include a memory for data storage, for example, a system memory, which may include various configurations of read-only memory (ROM) and random-access memory (RAM). In addition, the computer may include nonvolatile storage memory in which additional data can be stored, such as a hard disk drive.

Computer program instructions and data can be stored on a computer-readable medium, and can be loaded in whole or in part into the system memory of the general-purpose programmable machine to produce a specialized machine. The instructions can be executed by the processor to create means for implementing the disclosed functions by directing the machine to appropriately configure itself and perform a series of operational steps to implement the functions of the various disclosed systems, methods and computer program products. Accordingly, various storage media, such as magnetic data storage disks, optical disks, integrated circuit memories, or the like, can be configured to contain information that can direct the machine to implement the disclosed systems, methods and computer program products.

In various embodiments where the disclosed systems, methods and computer program products are implemented using a programmable device, such as a computer-based system or programmable logic circuit, it will be further appreciated that the disclosed systems, methods and computer program products generally can be implemented using any of various known or later-developed hardware description languages, such as VHDL; processor-specific programming languages, such as an assembly language; high-level programming languages, such as Cobol, Pascal, FORTRAN, C, C++, Ada, Java, or the like; or web application development and scripting languages, such as HTML, JavaScript, Perl, ASP, ColdFusion, JavaServer Pages (JSP), PHP, Python, Scheme, Tcl, or the like.

In addition, an embodiment of the present invention can include one or more input or output devices, for example, a pointing device such as a mouse, stylus, trackball, or touch screen; buttons or keys, such as a keyboard; a visual display device, such as a monitor; a voice-activated system; or the like. The display can provide for viewing text and graphical data, as well as a user interface to allow a user to request specific operations or provide input data.

Furthermore, it will be appreciated that an embodiment of the present invention can be implemented using a special-purpose, hardware-based system, for example, an application-specific integrated circuit (ASIC), or using some combination of special-purpose hardware and computer program code to perform the disclosed functionality. Likewise, an embodiment of the present invention can be implemented using a programmable hardware device, for example, a field-programmable gate array (FPGA), or using some combination of special-purpose, programmable, and general-purpose hardware devices and computer program code. Thus, the disclosure can support various combinations of means, steps or program instruction means for performing the specified functions.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer-implemented method of collecting address data in multifarious country formats, comprising:
sending a country selection form over a communication network to a remote computer;
receiving country selection input data indicating a selected country;
selecting a template corresponding to the selected country from a plurality of predetermined templates; and
composing a country-specific address form based on the template.

2. The computer-implemented method of claim 1, wherein the country selection form comprises a graphical user interface including a drop-down menu to allow a user to select the country selection input from a predetermined country list.

3. The computer-implemented method of claim 1, wherein the country selection form comprises a text markup language document.

4. The computer-implemented method of claim 1, wherein the template comprises a graphical user interface including a plurality of text input fields formatted in accordance with a country postal address standard to allow a user to enter textual address data.

5. The computer-implemented method of claim 1, wherein the address form comprises a text markup language document.

6. The computer-implemented method of claim 1, wherein the step of composing further includes accessing a country information database to retrieve country-specific data corresponding to the selected country, wherein the address form is further based on the country-specific data.

7. The computer-implemented method of claim 1, wherein the step of composing further includes adjusting a length of a text input field to conform to a country postal address standard.

8. The computer-implemented method of claim 1, wherein the step of composing further includes furnishing a country-specific label for a text input field.

9. The computer-implemented method of claim 1, wherein the step of composing further includes prepopulating at least a portion of a text input field with predetermined textual address data based on the selected country.

10. The computer-implemented method of claim 1, wherein the step of composing further includes integrating the address form into a customized entity form.

11. The computer-implemented method of claim 1, further comprising sending the address form over a communication network to the remote computer.

12. The computer-implemented method of claim 1, further comprising receiving address data based on address input data entered by a user.

13. The computer-implemented method of claim 12, further comprising storing the address data in an address database.

14. The computer-implemented method of claim 13, further comprising sending a confirmation over the communication network to the remote computer to indicate that the address data has been successfully received and stored.

15. A computer program product for collecting address data in multifarious country formats, including a computer-readable medium encoded with instructions configured to be executed by a processor in order to perform predetermined operations comprising:
sending a country selection form over a communication network to a remote computer;
receiving country selection input data indicating a selected country;
selecting a template corresponding to the selected country from a plurality of predetermined templates; and
composing a country-specific address form based on the template.

16. The computer program product of claim 15, wherein the country selection form comprises a graphical user interface including a drop-down menu to allow a user to select the country selection input from a predetermined country list.

17. The computer program product of claim 15, wherein the template comprises a graphical user interface including plurality of text input fields formatted in accordance with a country postal address standard to allow a user to fill in textual address data.

18. The computer program product of claim 15, wherein the step of composing further includes accessing a country information database to retrieve country-specific data corresponding to the selected country, wherein the address form is further based on the country-specific data.

19. The computer program product of claim 15, wherein the predetermined operations further comprise sending the address form over a communication network to the remote computer.

20. The computer program product of claim 15, wherein the predetermined operations further comprise receiving address data based on address input data entered by a user.

21. The computer program product of claim 20, wherein the predetermined operations further comprise storing the address data in an address database.

22. The computer program product of claim 21, wherein the predetermined operations further comprise sending a confirmation over a communication network to the remote computer to indicate that the address data has been successfully received and stored.

23. An address data collector to gather address data in multifarious national formats, comprising:
a country selector configured to send a country selection form over a communication network to a remote computer and receive country selection input data indicating a selected country; and
an address form composer configured to select a template corresponding to the selected country from a plurality of predetermined templates and compose a country-specific address form based on the template.

24. The address data collector of claim 23, wherein the country selection form comprises a graphical user interface including a drop-down menu to allow a user to select the country selection input from a predetermined country list.

25. The address data collector of claim 23, wherein the template comprises a graphical user interface including plurality of text input fields formatted in accordance with a country postal address standard to allow a user to enter textual address data.

26. The address data collector of claim 23, wherein the address form composer is further configured to access a country information database to retrieve country-specific data corresponding to the selected country, wherein the address form is further based on the country-specific data.

27. The address data collector of claim 23, wherein the address form composer is further configured to send the address form over a communication network to the remote computer.

28. The address data collector of claim 23, further comprising:
an address database; and
an address saver configured to receive address data based on address input data entered by a user and store the address data in the address database.
